(19) United States
(12) Patent Application Publication
(10) Pub. No.: US 2012/0200501 A1
(43) Pub. Date: Aug. 9, 2012

(54) HYPER MOUSE SYSTEMS

(76) Inventor: Matt Horvath, Rolla, MO (US)

(21) Appl. No.: 13/360,172

(22) Filed: Jan. 27, 2012

Related U.S. Application Data
(60) Provisional application No. 61/439,099, filed on Feb. 3, 2011.

(51) Int. Cl. G06F 3/033

(52) U.S. Cl. 345/166; 345/163

(57) ABSTRACT

Hyper Mouse Systems comprising a combined beverage holder and pointing device for communicating and remotely operating an electronic device. The beverage holder of Hyper Mouse Systems may have an ergonomic profile comprising a finger handle and a thumb handle. The beverage holder may further comprise a round inner-cavity comprising a holder base which may be impermeable to liquid. The holder base may also comprise adjustable grips for retaining beverage containers of varying sizes. In addition, the beverage holder may comprise a pair of handle recesses for receiving a handle of a beverage container comprising a handle (such as a mug). The pointing device of Hyper Mouse Systems may comprise a pair of clickable buttons, a thumb scrolling wheel, and a surface motion sensor for detecting movement about a surface. Hyper Mouse Systems enables a user to drink a beverage retained by beverage holder while simultaneously remotely operating an electronic device.

### CROSS-REFERENCE TO RELATED APPLICATION

The present application is related to and claims priority from prior provisional application Ser. No. 61/439,099, filed Feb. 3, 2011 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### FIELD OF THE INVENTION

The present invention relates generally to the field of computer mouse art and more specifically relates to a wireless mouse and cup holder combination.

### DESCRIPTION OF THE RELATED ART

A mouse is a pointing device that functions by detecting two-dimensional motion relative to its supporting surface. A mouse typically consists of an object held under one of the user's hands, with one or more buttons. It sometimes features other elements, such as “wheels”, which allow the user to perform various system-dependent operations, or extra buttons or features that can add more control or dimensional input. The mouse's motion typically translates into the motion of a cursor on a display, which allows for fine control of a graphical user interface. Modern mice may use laser to track movement relative to the supporting surface.

Many individuals enjoy drinking hot tea or coffee while working at their computers. However, doing so may be logistically difficult. Consumers may often use the same hand to navigate a mouse and to bring the coffee cups to their lips, but cannot typically accomplish both tasks at the same time. Users may be required to move their hands from the mice to their cups each time one of the items is needed, and may also be required to constantly move their cups out of the pathways of the mice.

Various attempts have been made to solve the above-mentioned problems such as those found in U.S. Pat. Nos. 5,533,697 to Fletcher et al; 6,332,533 to Howisen; and U.S. Pub. No. 2010/0108755 to Fuerstenberg et al. This prior art is representative of multi-functional mouse accessories. None of the above inventions and patents, taken either singly or in combination, is seen to describe the invention as claimed.

Ideally, a pointing device and beverage holder should be user-friendly and, yet, would operate reliably and be manufactured at a modest expense. Thus, a need exists for a reliable hyper mouse system to enable a user to drink a beverage while remotely operating a second electronic device and to avoid the above-mentioned problems.

### BRIEF SUMMARY OF THE INVENTION

In view of the foregoing disadvantages inherent in the known pointing device and beverage holder art, the present invention provides a novel hyper mouse system. The general purpose of the present invention, which will be described subsequently in greater detail, is to provide a beverage holder member comprising a pointing device for communicating with a second electronic device.

The beverage holder member as described herein may comprise a finger handle and a thumb handle for comfortable use by a left-handed user or a right-handed user. Underneath the finger handle may be at least two clickable buttons for remotely operating the second electronic device. Underneath the thumb handle may be a scroller wheel for use by the thumb. The scroller wheel may further operate the second electronic device. The beverage holder member may further comprise a first handle recess and a second handle recess. Each handle recess preferably comprises an open rectangular gap space along a perimeter of the beverage holder member. The handle recess is designed for receiving a handle of a beverage container when the container is being retained by the beverage holder member.

In a preferred embodiment of the present invention, the pointing device comprises a computer mouse (functions as) and the second electronic device comprises a computer. The pointing device of the preferred embodiment is in wireless communication with the second electronic device. This may be accomplished via a USB transceiver which may be plugged into a USB port of the second electronic device. The pointing device may integrally comprise a transmitter for communicating with the USB transceiver. In the wireless embodiment, the beverage holder member may comprise a battery compartment for receiving batteries. The batteries may provide power to the pointing device.

In an alternative embodiment of the present invention, the pointing device may comprise a cable for connecting to the second electronic device in hard-wired versions. The cable may be a standard mouse cable, USB cable, or the like. In the wired embodiment, the pointing device may be powered by the second electronic device and therefore does not require batteries.

The beverage holder member is designed to accommodate various sized beverage containers. Beverage containers may include, but are not limited to, coffee mugs, insulated mugs non-insulated mugs, bottles, cans, glasses, cups, and beverage cartons. The beverage member comprises a holder base, which may comprise adjustable grips. The adjustable grips may be used to substantially secure the bottom of the beverage container. The adjustable grips are removable, which may be ideal for a beverage container with a wide bottom. The adjustable grips may be added and maneuvered for a beverage container with a narrow bottom to provide beverage container security during an ‘in-use’ condition. Because the user will be moving the pointing device about a planar surface, it is important that the drink be securely retained within the holder base of the beverage member to avoid accidental spillage of the beverage.

The present invention holds significant improvements and serves as a novel beverage holder and pointing device system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, hyper mouse systems, constructed and operative according to the teachings of the present invention.

FIG. 1 is a perspective view illustrating a hyper mouse system comprising a beverage holder member and a pointing device to wirelessly operate a computer according to a preferred embodiment of the present invention.

FIG. 2A is a perspective view illustrating a first side of the beverage holder member comprising a holder base with adjustable grips, a finger handle, two handle recesses, and two clickable buttons according to an embodiment of the present invention of FIG. 1.

FIG. 2B is a perspective view illustrating a second side of the beverage holder member comprising a thumb handle and a scroller wheel according to an embodiment of the present invention of FIG. 1.

FIG. 3A is a perspective view illustrating the beverage holder member retaining a bottle during an ‘in-use’ condition according to an embodiment of the present invention of FIG. 1.

FIG. 3B is a side perspective view illustrating a user drinking a beverage from a mug which is retained by the beverage holder member during an ‘in-use’ condition according to an embodiment of the present invention of FIG. 1.

FIG. 4 is a perspective view illustrating a bottom portion of the beverage holder member comprising a surface motion sensor according to an embodiment of the present invention of FIG. 1.

FIG. 5 is a perspective view illustrating a wireless mouse assembly according to an embodiment of the present invention of FIG. 1.

FIG. 6 is a perspective view illustrating an alternative wired embodiment of the present invention during an ‘in-use’ condition.

FIG. 7 is a flowchart illustrating a method of using hyper mouse systems according to an embodiment of the present invention of FIGS. 1-6.

The various embodiments of the present invention will hereinafter be described in conjunction with the appended drawings, wherein like designations denote like elements.

### DETAILED DESCRIPTION

As discussed above, embodiments of the present invention relate to a hyper mouse system, and more particularly to a beverage holder member for accommodating a beverage container of varying sizes and optionally having handles, wherein the beverage holder comprises a pointing device for remotely communicating with a second electronic device.

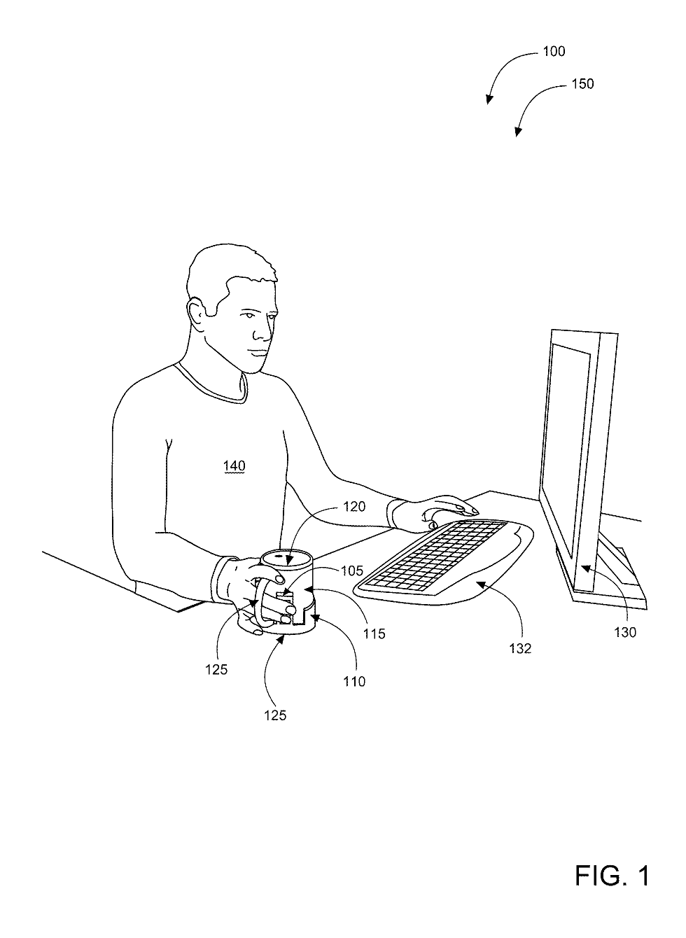

Referring now to the drawings by numerals of reference there is shown in FIG. 1, a perspective view of hyper mouse systems 100 during ‘in-use’ condition 150 according to a preferred embodiment of the present invention. Hyper mouse systems 100 may comprise beverage holder member 110 for retaining beverage container 120. Hyper mouse systems 100 may further comprise pointing device 125 for remotely communicating with electronic device 105.

As shown in FIG. 1, pointing device 125 of hyper mouse systems 100 may be used to remotely operate computer 130 similar to a traditional mouse. User 140 may simultaneously drink a beverage from beverage container 120 comprising beverage container handle 122 which may be retained by beverage holder member 110 while operating electronic device 105 comprising computer 130 via pointing device 125. In doing so, user 140 may save time and energy. Time may be saved as user 140 will not have to lose the time it takes by removing hand from a conventional mouse to lift beverage container 120 to consume a liquid beverage. Energy may be also saved as an arm of user 140 is not being lifted, stretched, or maneuvered as much. This may be optimal for user 140 who may have achy or tired muscles, or user 140 who may be either injured, elderly, or otherwise disabled. As shown in FIG. 1, beverage container 120 may comprise mug 190 having beverage container handle 122. Beverage container 120 does not serve as an obstacle when using the present invention.

It should be noted that hyper mouse systems 100 is designed to communicate with electronic device 105. In a preferred embodiment, hyper mouse system 100 is designed to communicate with computer 130. However, it should be appreciated that electronic device 105 may comprise a PDA, tablet, smart phone, television, or other computer device that may be used with pointing device 125.

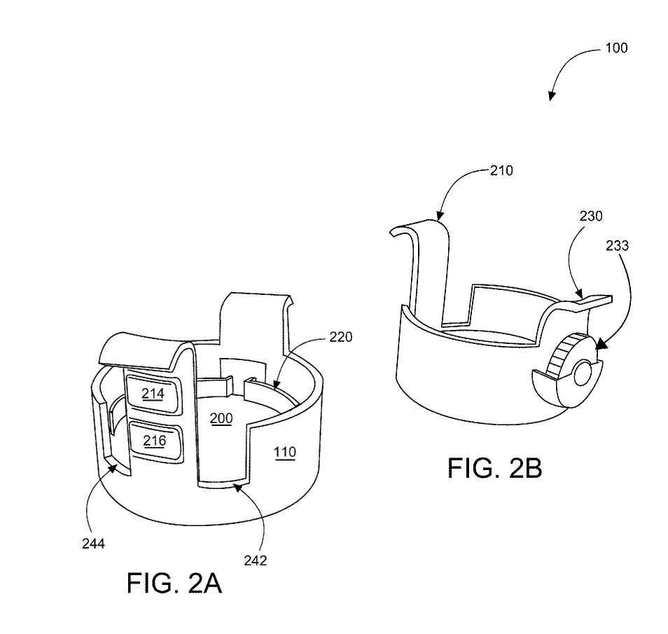

Referring now to FIG. 2A, illustrating a perspective view of a first side of hyper mouse systems 100. As shown, hyper mouse systems 100 may comprise holder base 200 located within an inner-cavity of beverage holder member 110. Holder base 200 preferably comprises a solid base which may be substantially impermeable to a liquid from a top side. In such a manner, should beverage 120 be accidentally spilled by user 140, a liquid from beverage 120 shall not permeate holder base 200 thereby protecting pointing device 125, and preserving its longevity.

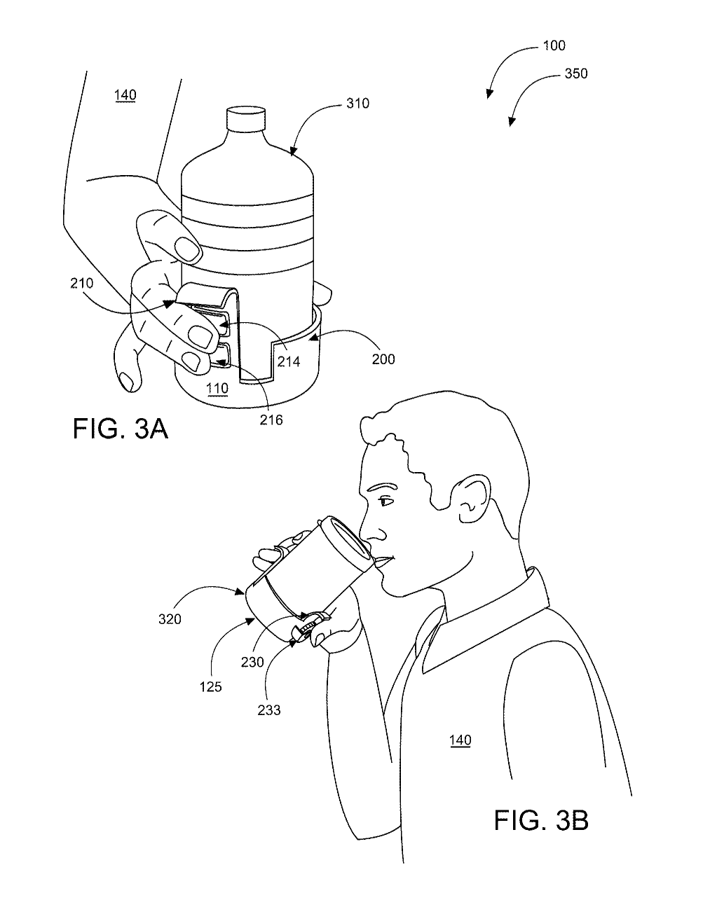

As further seen in FIG. 2A, holder base 200 may comprise adjustable grips 220 for securely retaining beverage 120. Adjustable grips 220 may comprise a flexible, pliable material, such as foam, rubber, or the like, and may be designed in such a manner so that they may fold outward from a wall formed by the round inner-cavity of beverage holder member 110. As such, user 140 may fold outward adjustable grips 220 to provide filler for the gap space between the bottom of a beverage container holding beverage 120 and the wall of the round inner-cavity of beverage holder member 110. In such a manner, adjustable grips 220 provide a means to securely retain and accommodate beverage containers of varying base sizes. For example, if beverage 120 is contained by mug 190, having a wide base, adjustable grips 220 may fold up and inward against the wall of the inner-cavity of beverage holder member 110. However, if the beverage container is bottle 310, (as shown in FIG. 3A) having generally a narrower base, adjustable grips 220 may fold outward from the wall of the inner-cavity, thereby providing security and stability to bottle 310 retained by beverage holder member 110.

In continuing to refer to FIG. 2A, the first side of hyper mouse systems may comprise finger handle 210. Finger handle 210 may comprise a hooked-shape notch which may extend vertically upward from beverage holder member 110. The notch is ergonomically designed so that it may rest on top of an index finger or a middle finger of user 140. Hyper mouse systems 100 may further comprise comfort pads for isolating finger and thumb from contact with plastic or other material of finger handle 210 for example (to prevent calluses or the like.) As shown, first clickable button 214 and second clickable button 216 may be located on an outer portion of finger handle 210. First clickable button 214 and second clickable button 216 may be clicked inward by user 140 to operate electronic device 105 as illustrated best in FIG. 1. Generally, first clickable button 214 and second clickable button 216 may each perform a different function of pointing device 125. In an embodiment of the present invention, user 140 may customize first clickable button 214 and second clickable button 216 by alternating the functionality of each button.

In still referring to FIG. 2A, beverage holder member 110 may comprise first handle recess 242 and second handle recess 244. First handle recess 242 and second handle recess 244 may each comprise an open rectangular gap space located directly to the left and to the right of finger handle 210 along a perimeter of beverage holder member 110 as shown best in FIG. 2A. It should be appreciated that first handle recess 242 and second handle recess 244 are designed for receiving handle of a beverage container when the container is being retained by the beverage holder member. It should be appreciated that first handle recess 242 and second handle recess 244 are designed so that hyper mouse systems 100 may be used by user 140 comprising either a left-handed individual or a right-handed individual. In such a manner, beverage container handle 122 of beverage container 120 may be inserted through first handle recess 242 to optimally accommodate the left-handed individual, or through second handle recess 244 to optimally accommodate the right-handed individual.

Referring now to FIG. 2B, illustrating a perspective view of a second side of hyper mouse systems 100. As shown, beverage holder member 110 may comprise thumb handle 230 and scroller wheel 233 according to an embodiment of the present invention of FIG. 1. Thumb handle 230 may comprise a hooked-shape notch which may extend vertically upwardly from beverage holder member 110. The notch may be ergonomically designed so that it may comfortably rest on top of a thumb of user 140. Although not shown, it should be appreciated that finger handle 210 and thumb handle 230 may comprise a soft, comfortable padding on the underside of finger handle 210 and thumb handle 230 for additional comfort when beverage holder member 110 is held by user 140.

As shown in FIG. 2B, scroller wheel 233 may comprise a round shaped disk held in place on the second side of beverage holder member 110 by a scroller wheel holder. Scroller wheel 233 may comprise tiny divots along a circumference such that scroller wheel 233 may be easily manipulated by a thumb of user 140. In one embodiment of the present invention, a screw or rivet may be used to hold scroller wheel 233 in place within the scroller wheel holder. In such a manner, scroller wheel 233 may be manipulated by user 140 so that it may be rotated in either direction. As will be discussed subsequently in greater detail, user 140 may rotate scroller wheel 233 to facilitate operation of electronic device 105.

In turning now to FIG. 3A, showing a perspective view beverage holder member 110 retaining bottle 310 during ‘in-use’ condition 350 according to an embodiment of the present invention of FIG. 1. As shown, user 140 comprising a right-handed individual may hold beverage holder member 110 by positioning an index finger or a middle finger of a right hand underneath finger handle 210. In such a manner, user 140 may press first clickable button 214 and second clickable button 216 with two available fingers that will be comfortable positioned over first clickable button 214 and second clickable button 216.

Referring now to FIG. 3B, illustrating a side perspective view of hyper mouse systems 100 during ‘in-use’ condition 350 according to an embodiment of the present invention of FIG. 1. As shown, user 140 is drinking a beverage from beverage container 120 comprising insulated mug 320 which is securely retained by beverage holder member 110. Further, user 140 is able to manipulate first clickable button 214 and second clickable button 216 with a right hand of user 140 while sipping the beverage. Additionally, user 140 is able to manipulate scroller wheel 233 with a thumb of a left hand of user 140 while simultaneously consuming the beverage.

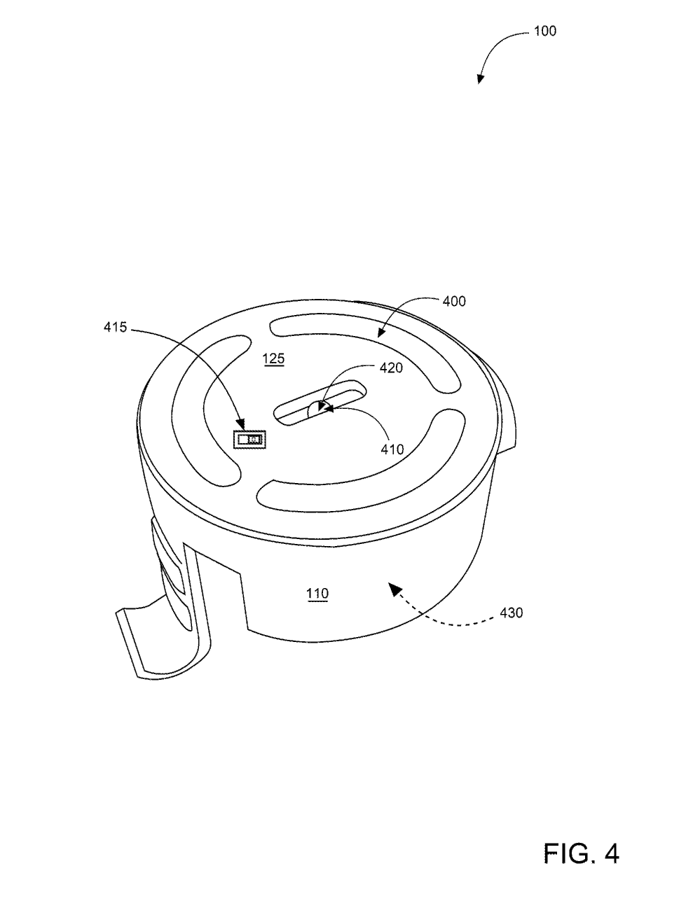

In turning now to FIG. 4 showing a perspective view of a bottom portion of beverage holder member 110 comprising pointing device 125 according to an embodiment of the present invention of FIG. 1. As shown, pointing device 125 may comprise surface motion sensor 400 which may generally detect movement of beverage holder member 110 about a surface. Surface motion sensor 400 may comprise light emitting diode 410, photodiodes 420, and on/off switch 415. When on/off switch 415 is in an “on” position, light emitting diodes 410, which may comprise infrared LEDs, may shine through surface motion sensor 400. When light emitted by light emitting diode 410 comes into contact with a surface, photodiodes 420 may gather light pulses to convert the movement to X and Y vectors. In such a manner, pointing device 125 may be optimally used to control a pointer of electronic device 105, such as computer 130. Alternatively, pointing device 125 may comprise a laser mouse, whereby a laser assembly may emit coherent laser light which may be detected by surface motion sensor 400 to detect movement. When on/off switch 415 is in an “off” position, power to surface motion sensor 400 is disconnected and pointing device 125 will be in an “off-condition”.

In still referring to FIG. 4, hyper mouse systems 100 may integrally comprise pointing device circuitry assembly 430 for operating pointing device 125. As shown, pointing device circuitry assembly 430 may be installed within confines of beverage holder member 110. Pointing device circuitry assembly 430 may comprise at least one circuit board and a plurality of connection cables. First clickable button 214 and second clickable button 216 may be in communication with the circuit board via the connection cables. Scroller wheel 233 may be in communication with the circuit board via the connection cables. Surface motion sensor 400 may be in communication with the circuit board via the connection cables. Further, a transmitter may be in communication with the circuit board via the connection cables.

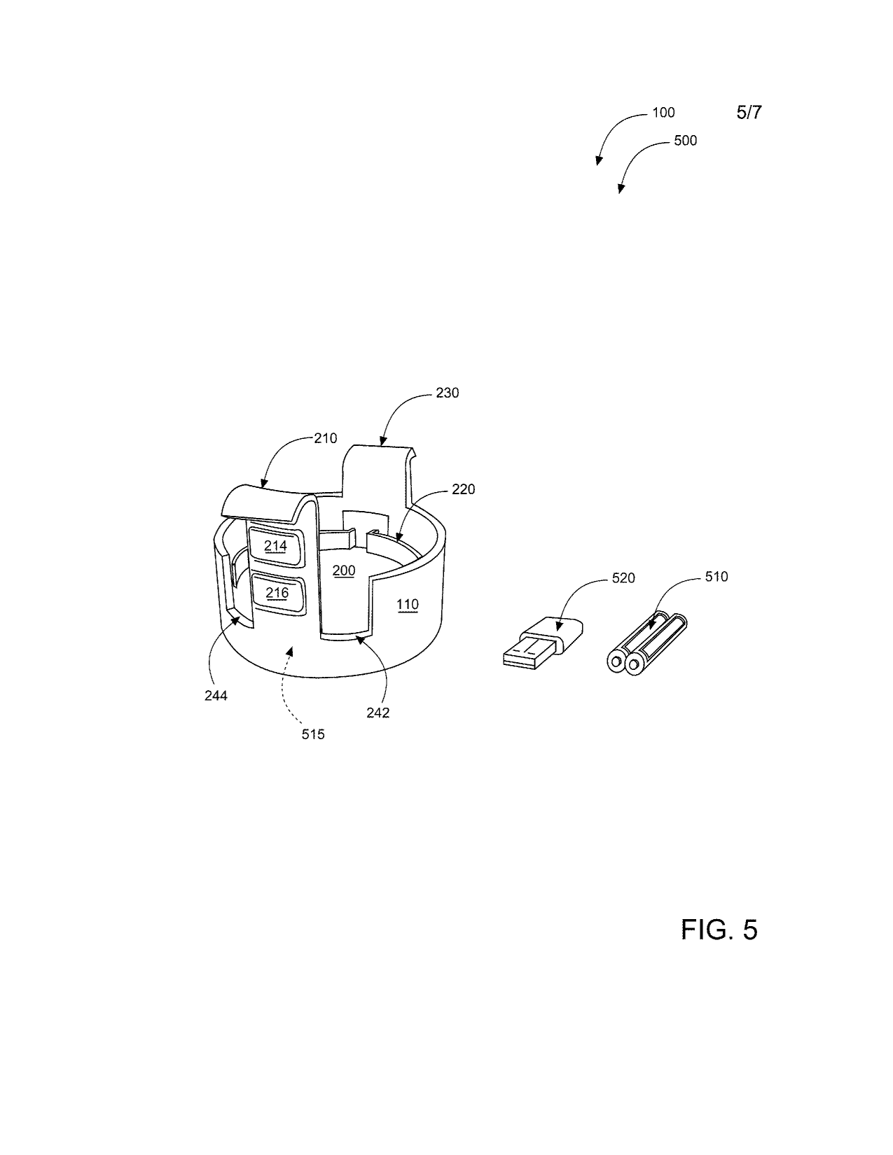

Referring now to FIG. 5, showing hyper mouse system 100. Hyper mouse system 100 may be sold as wireless mouse assembly 500 comprising the following parts: at least one beverage holder member 110 comprising pointing device 125; at least one holder base 200; at least one finger handle 210; at least one first clickable button 214; at least one second clickable button 216; at least one adjustable grip 220; and at least one thumb handle 230; at least one scroller wheel 233; at least one surface motion sensor 400; at least one USB transceiver 520; and set of user instructions. Hyper mouse systems 100 may be manufactured and provided for sale in a wide variety of sizes and shapes for a wide assortment of applications.

In an embodiment of hyper mouse systems 100, the transmitter may transmit signals from the circuit board of pointing device circuitry assembly 430 to USB transceiver 520. It should be appreciated that when on/off switch 415 is turned to the off position, battery power of batteries may be conserved. Further, the circuit board of hyper mouse systems 100 may comprise a means for entering a “sleep mode” when surface motion sensor 400 does not detect movement after certain length of time. In such a manner, battery power may be conserved when user 140 forgets to move on/off switch 415 into the off position.

Hyper mouse systems 100 may comprise beverage holder member 110. Beverage holder member 110 may comprise a round shaped inner-cavity for receiving and retaining beverage container 120. Beverage holder member 110 may comprise finger handle 210 and thumb handle 230 for providing a comfort-grip of beverage holder member 110 for user 140 who may be either left-handed right-handed. Beverage holder member 110 may also comprise holder base 200, which may comprise a solid base impermeable to a liquid from a top side. Holder base 200 may comprise adjustable grips 220 for securely retaining beverage container 120 comprising varying sizes. Adjustable grips 220 may comprise a pliable, spongy substance, such as foam or rubber, for securely retaining beverage container 120 within holder base 200 of beverage holder member 110. Further, beverage holder member 110 may comprise first handle recess 242 and second handle recess 244. First handle recess 242 and second handle recess 244 may each comprise a rectangular gap space designed to accommodate a handle positioned according to user-preference (right or left-handed orientation.)

Pointing device 125 may comprise first clickable button 214, second clickable button 216, scroller wheel 233, surface motion sensor 400, light emitting diode 410, on/off switch 415, photodiodes 420, and pointing device circuitry assembly 430. First clickable button 214 and second clickable button 216 may be clicked by user 140 and may each perform a different function in operating electronic device 105. Scroller wheel 233 may be rotated in either direction by user 140 which may also perform a function in operating electronic device 105. Surface motion sensor 400, light emitting diode 410, and photodiodes 420 may cooperatively detect movement of pointing device 125 about a surface. A pointer icon of electronic device 105 may follow the movement of pointing device 125 when on/off switch 415 is in an “on” position.

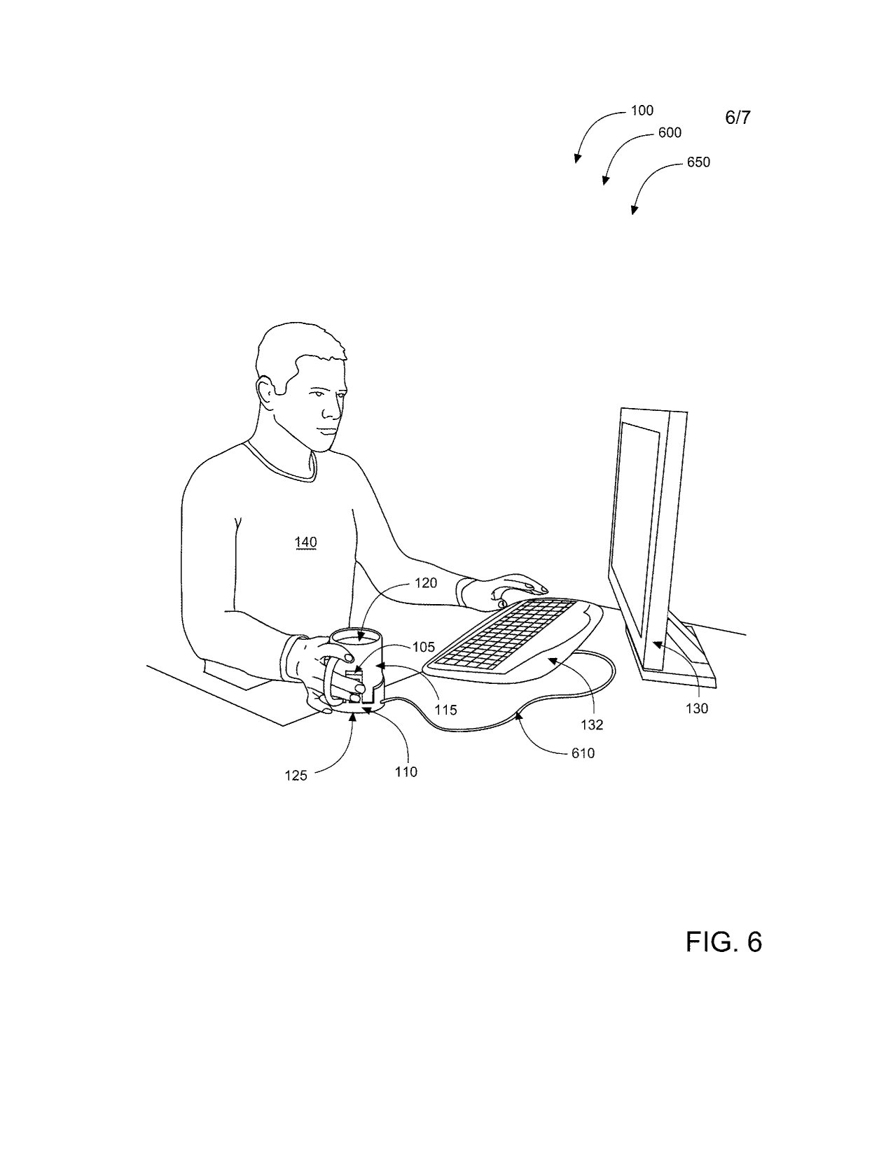

Referring now to FIG. 6, illustrating a perspective view of hyper mouse systems 100 during ‘in-use’ condition 650 according to an alternative embodiment of the present invention. As shown, hyper mouse systems 100 may comprise wired embodiment 600 whereby pointing device 125 may be connected (hard-wired) to electronic device 105 via pointing device cable 610. In this embodiment, hyper mouse systems 100 may receive power to operate pointing device circuitry assembly 430 directly from electronic device 105 as opposed to batteries 510. Pointing device cable 610 may comprise a standard mouse cable, USB cable, or the like.

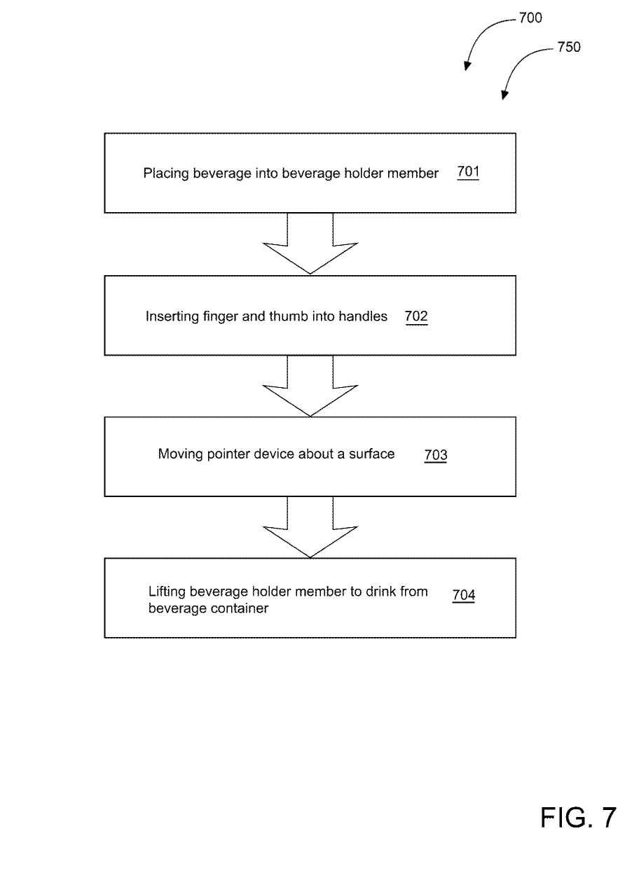

FIG. 7 shows flowchart 750 illustrating method of use 700 of hyper mouse systems 100 according to a preferred embodiment of the present invention of FIGS. 1-5. Method of use 700 may comprise the steps of: step one 701 placing beverage 120 into beverage holder member 110, step two 702 inserting finger into finger handle 210 and thumb into thumb handle 230, step three 703 moving pointing device 125 about a surface to remotely operate electronic device 105, and step four 704 lifting beverage holder member 110 to drink beverage 120.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An ergonomic beverage holder and wireless pointing device comprising:
at least one beverage holder member with an inner volume and a round inner-cavity;
at least one pointing device assembly comprising;
at least one first clickable button;
at least one second clickable button;
at least one scroller wheel;
at least one surface motion sensor;
at least one transmitter;
at least one pointing device circuitry assembly; and
at least one power supply;
wherein said beverage holder member comprises said round inner-cavity for retaining a beverage container;
wherein said pointing device circuitry assembly is installed within confines of said inner volume of said beverage holder member;
wherein said pointing device circuitry assembly comprises at least one circuit board and a plurality of connection cables;
wherein said first clickable button and said second clickable button are in communication with said circuit board via said connection cables;
wherein said scroller wheel is in communication with said circuit board via said connection cables;
wherein said surface motion sensor is in communication with said circuit board via said connection cables;
wherein said transmitter is in communication with said circuit board via said connection cables;
wherein said power supply provides power to said pointing device assembly; and
wherein said ergonomic beverage holder and said wireless pointing device is useable by a user for simultaneously retaining a beverage container and communicating with a second electronic device.

2. The ergonomic beverage holder and wireless pointing device of claim 1, wherein said beverage holder member further comprises an index finger handle and a thumb handle for providing a comfortable grip for either hand of said user.

3. The ergonomic beverage holder and wireless pointing device of claim 2, wherein said round inner-cavity of said beverage holder member further comprises a first handle recess and a second handle recess, wherein said first handle recess and said second handle recess comprises a gap space for receiving a handle of said beverage container.

4. The ergonomic beverage holder and wireless pointing device of claim 3, wherein said first handle recess is optimally used by a right-handed user.

5. The ergonomic beverage holder and wireless pointing device of claim 3, wherein said second handle recess is optimally used by a left-handed user.

6. The ergonomic beverage holder and wireless pointing device of claim 2, wherein said inner-cavity of said beverage holder member comprises a solid base substantially impermeable to a liquid from a top side.

7. The ergonomic beverage holder and wireless pointing device of claim 6, wherein said beverage holder member comprises adjustable retainer grips.

8. The ergonomic beverage holder and wireless pointing device of claim 1, wherein said pointing device comprises a mouse.

9. The ergonomic beverage holder and wireless pointing device of claim 8, wherein said mouse comprises a mouse cord for connecting to said second electronic device.

10. The ergonomic beverage holder and wireless pointing device of claim 1, wherein said second electronic device comprises a transceiver in wireless communication with said transmitter of said pointing device assembly.

11. The ergonomic beverage holder and wireless pointing device of claim 10, wherein said second electronic device comprises a computer.

12. The ergonomic beverage holder and wireless pointing device of claim 10, wherein said second electronic device comprises a PDA.

13. The ergonomic beverage holder and wireless pointing device of claim 1, wherein said surface motion sensor comprises at least one light-emitting diode and an imaging array of photodiodes to detect movement relative to an underlying surface of said beverage holder member.

14. The ergonomic beverage holder and wireless pointing device of claim 1, wherein said beverage container comprises a bottle.

15. The ergonomic beverage holder and wireless pointing device of claim 1, wherein said beverage container comprises a mug.

16. The ergonomic beverage holder and wireless pointing device of claim 1, wherein said beverage container comprises a can.

17. The ergonomic beverage holder and wireless pointing device of claim 1, wherein said beverage container comprises an insulated mug.

18. The ergonomic beverage holder and wireless pointing device of claim 1, wherein said power supply comprises batteries.

19. An ergonomic beverage holder and wireless pointing device comprising:
a beverage holder member comprising an index finger handle and a thumb handle for providing a comfort-grip for either a left hand or a right hand of said user, wherein said beverage holder member further comprises a solid base impermeable to a liquid from a top side, said solid base comprising adjustable retainer grips;
at least one pointing device assembly comprising a computer mouse, said pointing device assembly comprising;
a first clickable button;
a second clickable button;
a scroller wheel;
a surface motion sensor, said surface motion sensor comprising at least one light-emitting diode and an imaging array of photodiodes to detect movement relative to an underlying surface of said beverage holder member;
a transmitter;
a pointing device circuitry assembly;
circuit board;
a plurality of connection cables; and
a power supply comprising DC batteries;
wherein said beverage holder member comprises a round inner-cavity for retaining a beverage container, said round inner-cavity comprises a first handle recess and a second handle recess, wherein said first handle recess and said second handle recess comprises a gap space for receiving a handle of said beverage container;
wherein said pointing device circuitry assembly is installed within an inner volume of said beverage holder member;
wherein said pointing device circuitry assembly comprises said circuit board and said plurality of connection cables;
wherein said first clickable button and said second clickable button are in communication with said circuit board via said connection cables;
wherein said scroller wheel is in communication with said circuit board via said connection cables;
wherein said surface motion sensor is in communication with said circuit board via said connection cables;
wherein said transmitter is in communication with said circuit board via said connection cables;
wherein said power supply comprising said DC batteries provides power to said pointing device assembly; and
wherein said ergonomic beverage holder and said wireless pointing device is useable by a user for retaining and releasing a beverage container for beverage consumption while simultaneously communicating with a second electronic device.

20. A method of using an ergonomic beverage holder and wireless pointing device comprising the steps of:
placing a beverage container into a round inner-cavity of a beverage holder member;
inserting an index finger and a thumb into contact with an index finger handle and a thumb handle of said beverage holder member;
moving a pointing device of said beverage holder member about a surface to operate a second electronic device; and
lifting said beverage holder member via said index finger handle and said thumb handle to a mouth of said user to drink from said beverage container.
